(19) United States
(12) Patent Application Publication
(10) Pub. No.: US 2020/0379613 A1
(43) Pub. Date: Dec. 3, 2020

(54) DISTRIBUTED COMPUTING SYSTEMS, GRAPHICAL USER INTERFACES, AND PROCESSOR-EXECUTABLE LOGIC FOR PROVISIONING PHI-BASED COLOR EVALUATION AND HARMONIZATION

(71) Applicant: Chameleon Power, Inc., Novi, MI (US)

(72) Inventors: Daniel J. Dempsey, Northville, MI (US); William A. Westrick, Fort Wayne, IN (US); Philip Kenyon, Basking Ridge (GB)

(73) Assignee: Chameleon Power, Inc., Novi, MI (US)

(21) Appl. No.: 16/888,182

(22) Filed: May 29, 2020

Related U.S. Application Data
(60) Provisional application No. 62/855,325, filed on May 31, 2019.

(51) Int. Cl. G06F 3/0482; G06T 15/04

(52) U.S. Cl. CPC G06F 3/0482; G06T 15/04

(57) ABSTRACT

Presented are computing systems and control logic for provisioning quantitative color analysis to derive color harmony, devices for executing such logic, and methods for operating such systems/devices. A method of analyzing color selections to generate matching colors includes transmitting, via a server computer over a distributed computing network to a user's personal computing device, multiple user-selectable colors organized as discrete hues distributed over a human-perceivable visible spectrum. The server computer receives the user's selection(s) from the user-selectable colors, which includes one or more of the discrete hues. These selection(s) is/are imported into a device-independent, three-axis color space model; a geometric object characterized by the mathematical golden ratio is built into the color space model. The server computer generates a list of colors harmonized with the user-selected color(s) by correlating the geometric object with the discrete hue(s) in the color space model. The user's personal computing device displays the harmonized colors.

### CLAIM OF PRIORITY AND CROSS-REFERENCE TO RELATED APPLICATION

This application claims the benefit of, and priority to, U.S. Provisional Patent Application No. 62/855,325, which was filed on May 31, 2019, and is incorporated herein by reference in its entirety and for all purposes.

### TECHNICAL FIELD

The present disclosure relates generally to interactive computing systems and processor-executable control logic for digital image analysis. More specifically, aspects of this disclosure relate to networked computing systems and web engines for quantitatively analyzing a set of one or more colors to generate an objective list of harmonized colors.

### BACKGROUND

Color selection, evaluation, balancing, and matching—more generally designated as “color harmony”—has long been limited to a subjective evaluation process that makes a distinction between harmonious and non-harmonious combinations of visible color. Attributing importance to particular colors and their combinations may be subjectively established by an individual through the systematic application of “laws of harmony”—laws of contrast and laws of analogous colors—including simultaneous and successive contrasts of color. Some theorists attribute importance to the subjective assessment of sequential organization, balance, and order in deriving color harmony. Other practitioners claim that color harmony is derived from the juxtaposition of colors selected on an orderly plan that can be recognized and, hence, “emotionally appreciated.”

The contents of many existing color collections are typically developed based on available “popularity data,” the personal selections of “skilled professionals,” or variable percentages of pigment or colorants used in formulations. Color Order Systems (COS) may be used to create pre-determined spacing in a color arrangement based on existing methodologies for visually describing color space to achieve a desired aesthetic based on a pre-determined requirement for a sequence of colors. Displaying and selecting color combinations from existing palettes may be structured to assist with the selection process and to create a palette that is overall aesthetically pleasing. The method of color selection from existing collections is often premised on spatial variations between colors that are either random in color space or based on even or linear progressions. Despite the notion of color harmony being studied for over two centuries, there are few methodologies presented that mathematically model the relationship between colors that humans find visually appealing through objective, quantitative techniques.

### SUMMARY

Disclosed herein are distributed computing systems with attendant control logic for provisioning the quantitative analysis of colors to objectively derive color harmony, integrated circuit (IC) devices for executing such control logic, methods for operating such systems, and processor-executable algorithms and computer-readable media for carrying out such logic. In an example, there is presented a phi-color harmony web engine with backend server-class hardware support that implements the concepts of Phi and the Golden Rectangle to generate color combinations projected to be aesthetically pleasing with a user-input set of one or more colors. In this example, the mathematical Golden Ratio—or “Phi”—is implemented in conjunction with Commission Internationale de l'Eclairage lab model (CIELAB) color space (or other suitable 3D color space model) to decode the relationship of color harmony. As an exemplary application, an objective list of one or more lipstick colors can be derived by Phi proportions in a way that ties together a person's skin color, eye color, lip color, hair color, etc., to create a harmonious color combination.

The concept of Phi is a mathematical relationship in which two quantities are “in the Golden Ratio”: the ratio of the two quantities is the same as the ratio of their sum to the larger of the two quantities. In general, Phi and the concept of golden proportions relates to the size relationship between multiple points. A rectangle, for example, may be designated as a “Golden Rectangle” if the ratio between the rectangle's short (breadth) side and long (length) side is 1: φ, where φ is approximately equal to 1.618. In a linear perspective, Phi may be typified as the distance relationship between two line segments A and B, where B>A and A:B=B:(A+B). The first dated definition of Phi was presented by Euclid in his book “Elements,” which was published in or around 265 BC. There are many instances in which the concept of Phi and the Golden Ratio occurs in nature—found in the shapes of stars, pinecones, seashells, etc. —in art—linked to the human body with Leonardo da Vinci's Vitruvian Man—and in architecture—the Great Pyramids, the cathedral of Notre-Dame, etc. By contrast, the present disclosure provides a novel technique that applies Phi proportionality in the modern concepts and comprehension of color space and how certain color combinations create the appearance of harmony.

Aspects of this disclosure are directed to distributed computing systems, personal computing devices, web engines, and dedicated mobile software applications (“apps”) for carrying out any of the disclosed features. In an example, a distributed computing system includes a resident or remote memory device configured to store user inputs, processor-executable instructions, and related data. A communications device is configured to communicate, wired or wirelessly over a distributed computing network, with a remote database system and a user's personal computing device. A server computer with a processor is communicatively connected to the user's personal computing device via the communications device.

Continuing with the discussion of the above example, the server computer processor is programmed to transmit multiple user-selectable colors to the user's personal computing device. The user-selectable colors are organized and displayed for selection as a standardized set of discrete hues that are distributed over a visible spectrum perceivable by the human eye. The server computer then receives from the user's personal computing device a selection from the user-selectable colors, including one or more of the discrete hues. The selected color(s) are stored in the system's memory device and concomitantly imported into a device-independent, three-axis color space model. Prior to or contemporaneous therewith, a golden geometric object characterized by the mathematical Golden Ratio is built into the color space model. The processor generates a list of colors harmonized with the user-selected color(s) by correlating the golden geometric object with the one or more discrete hues imported into the color space model. The generated list of harmonized colors is transmitted to the personal computing device of the user.

Other aspects of the disclosure are directed to control logic, processor-executable, memory-stored computer readable media, and computer algorithms for provisioning any of the disclosed methods and techniques. In an example, a method is presented for analyzing one or more color selections to generate a list of matching colors. This representative method includes, in any order and in any combination with any of the above and below discussed options and features: transmitting, via a server computer over a distributed computing network to a personal computing device of a user, multiple user-selectable colors, the user-selectable colors being organized and displayed for selection as a standardized set of discrete hues distributed over a visible spectrum perceivable by a normal human eye; receiving, via the server computer over the distributed computing network from the personal computing device of the user, a selection from the user-selectable colors, the selection including one or more of the discrete hues; importing the selection of user-selectable colors into a device-independent three-axis color space model; building into the device-independent three-axis color space model a golden rectangle or other suitable golden geometric object characterized by the mathematical Golden Ratio; generating, via the server computer, a list of colors harmonized with the selection of user-selectable colors by correlating the golden geometric object with the one or more discrete hues in the device-independent three-axis color space model; and displaying, to the user via an electronic display of the personal computing device, a graphical representation of the generated list of harmonized colors.

Further aspects of this disclosure are directed to quantitative color analysis techniques for deriving color harmony. In an example, a method is presented for calculating matching (“ideal” or “recommended”) colors for color data input by a user. This representative method includes, in any order and in any combination with any of the above and below discussed options and features: receiving, by a computer device from the user via a human-machine interface, multiple color data files corresponding to user-input target colors; transforming, via the computer device, each of the color data files into a respective color coordinate point integrable with a three-axis color space model; importing the color coordinate points into the three-axis color space model; building, within this color space model, a golden geometric object based on the mathematical golden ratio and the imported color coordinate points; identifying, via the computer device, one or more matching colors harmonized with the color data files by correlating the golden geometric object with the color coordinate points imported into the color space model; and displaying the matching color(s) via an electronic display device, e.g., of the user's computer device.

Additional aspects of this disclosure are directed to intelligent computing architectures with deep learning artificial intelligence (AI) for phi-based color harmonization. For instance, a computing system is presented for identifying matching colors for user-input color data. The computing system includes a resident or remote memory device that stores therein a three-axis color space model, and a communications device that communicates with one or more personal computing devices of one or more users over a computing network. A system server computer is communicatively connected to the memory and communications devices. One or more processors of the system's server computer is/are programmed to receive, from the user's personal computing device, multiple color data files that correspond to user-selected target colors, and transform each color data file into a respective color coordinate point that is integrable with the three-axis color space model. The server computer then imports the color coordinate points into the color space model, and builds a golden geometric object within the color space model based on the golden ratio and the imported color coordinate points. The server computer identifies one or more matching colors harmonized with the color data files of the target colors by correlating the golden geometric object with the color coordinate points imported into the color space model. A digital representation of the matching color(s) is transmitted to the user's personal computing device for display via an electronic display device.

For any of the disclosed systems, methods, and devices, the three-axis color space model may be a device-independent, three-dimensional (3D) CIELab color space that defines colors independently of how the colors are created or displayed. In this instance, color data files may be transformed into color coordinates by identifying, for each color data file, a respective L*a*b color coordinate set. Each L*a*b color coordinate set includes: a lightness coordinate L* for a black-to-white (first) axis of the 3D CIELAB color space, a first color channel coordinate a* for a red-to-green (second) axis of the CIELAB color space, and a second color channel coordinate b* for a yellow-to-blue (third) axis of the CIELAB color space.

For any of the disclosed systems, methods, and devices, the golden geometric object may include an equiangular quadrilateral (rectangle) in which the ratio between the rectangle's short side length and long side length is approximately equal to 1.618. A golden spiral, e.g., a Fibonacci spiral with a logarithmic growth factor of approximately 1.618, may be located within the golden rectangle. Optionally, the golden geometric object may include an isosceles triangle in which a ratio between the length of the triangle's two short sides and the length of the triangle's long side is approximately equal to 1.618. It is within the scope of this disclosure to use other suitable golden shapes for color harmonization.

For any of the disclosed systems, methods, and devices, the computer processor may automate locating the golden geometric object within the color space model such that all of the imported color coordinate points are located within or on a boundary line of the golden geometric object. As a further option, the computer processor may dynamically define a color curve (e.g., Fibonacci spiral) within the golden geometric object, and shift the color curve to intersect with the imported color coordinate points of the user's target colors. In this instance, the computer processor may dynamically define multiple neighboring regions within the golden geometric object, and thereafter determine, for each color data file, within which of these regions the color curve intersects with the corresponding color coordinate point in the three-axis color space model.

For any of the disclosed systems, methods, and devices, the computer processor may receive one or more desired color types from a predefined set of user-selectable color types. In this instance, the computer processor determines, for each color data file based on the desired color type received from the user, a respective rule set associated with the region within which the color curve intersects with the corresponding color coordinate point. These rule sets may define the manner in which a matching color is located with respect to the color coordinate point within the color space model based on phi.

For any of the disclosed systems, methods, and devices, the computer processor may output one or more command signals to display to the user a predefined set of user-selectable color options; each user-selectable color options corresponds to a respective color data file. In this instance, receiving color data files may include receiving, from the user via the human-machine interface (HMI), multiple user selections from the predefined set of user-selectable color options. As another option, the computer device may be a server-class computer and the HMI may be a personal computing device of the user and/or an optical color sensor that may communicate with the server-class computer via a distributed computing network.

The above summary does not represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram illustrating a representative distributed computing system architecture for carrying out any of the disclosed selection, visualization, and color harmonization techniques in accordance with aspects of the present disclosure.

FIGS. 2A and 2B are two-dimensional (2D) representations of a three-dimensional (3D) color space model with a representative golden geometric object in the form of a golden rectangle for deriving harmonious colors for target colors in accord with aspects of the disclosed concepts.

FIGS. 3A and 3B are screenshots showing a representative 3D color space model with a phi-compliant golden triangle for deriving harmonious colors for target colors in accordance with aspects of the present disclosure.

FIGS. 4A and 4B are screenshots showing a representative 3D color space model with a phi-compliant golden rectangle and Fibonacci spiral for deriving harmonious colors for target colors in accordance with aspects of the present disclosure.

FIG. 5 is a flowchart illustrating a representative algorithm for performing quantitative analysis of user-input target colors to objectively derive a set of harmonious colors based on the golden ratio, which may correspond to memory-stored instructions executed by control logic circuitry, programmable electronic control unit, or other computer-based device or network of devices in accord with aspects of the disclosed concepts.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Technical Field, Background, Summary, Description of the Drawings, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” and “having,” including synonyms and permutations thereof, shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

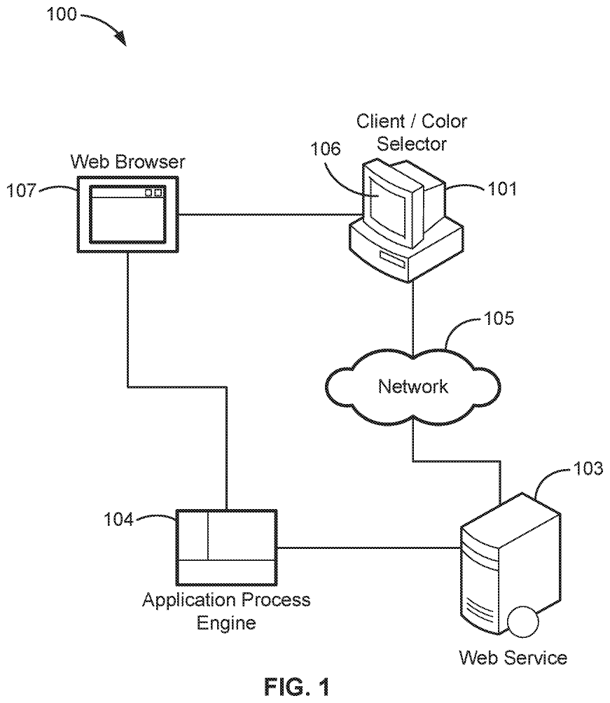

Referring now to the Figures, wherein like reference numbers refer to like features throughout the several views, there is shown illustrated in FIG. 1 a schematic diagram of a representative distributed computing system 100 operable for a user to perform electronic color selection, color data file transformation, golden object generation, and objective color harmony derivation. The illustrated computing system 100 is merely an exemplary application with which aspects and features of this disclosure may be practiced. In the same vein, implementation of the present concepts for color harmonization of cosmetics and personal healthcare products should also be appreciated as an exemplary application of the novel features disclosed herein. As such, it will be understood that aspects and features of this disclosure may be implemented through other computing system architectures, carried out online and offline via any suitable computing device, employ any applicable color space model, and may be utilized for any logically relevant application, including real-property construction and repair, interior design, commercial products, etc. Also note, the drawings presented herein are not necessarily to scale and are provided purely for instructional purposes. Thus, the specific and relative dimensions shown in the drawings are not to be construed as limiting. Lastly, only select components of the computing system have been shown and will be described in additional detail below. Nevertheless, the systems, methods, and devices discussed herein may include numerous additional and alternative features, and other commercially available peripheral hardware, for example, to achieve any or all of the described functions and operations of this disclosure.

Aspects of the present disclosure may implement a “Color Selection” software application for visualization and selection of one or more target colors, e.g., in one or more digital images provided by one or more electronic files input by a user (also referred to herein as “client”) and/or captured by an optical image sensor. In accordance with the representative distributed computing system 100 of FIG. 1, a Client/Color Selector node 101 includes a client's personal computing device that is programmed with Color Selection software wherein, in general, the software receives target color selections from a user. For example, the Client/Color Selector node 101 enables a user to remotely perform a color harmonizing session with a backend server-class host computer wherein one or more user-supplied or user-selected target colors are associated with corresponding digital image files of the target colors. In this way, a set of matching (e.g., best, ideal, preferred, desired, optimal) colors may be dynamically derived for the target colors online at a web site via a public communication network, such as the Internet.

With continuing reference to FIG. 1, a Web Service 103 may be embodied as a host system implemented through a high-speed, server-grade computing device or a mainframe computer capable of handling bulk data processing, resource planning, and transaction processing. For instance, the Web Service 103 may operate as the host in a client-server interface for conducting any necessary data exchanges and communications with one or more “third party” servers to complete a particular transaction. Alternatively, the Web Service 103 may be implemented as a middleware node to provide different functions for dynamically onboarding heterogeneous devices, multiplexing data from each of these devices, and routing the data through reconfigurable processing logic for processing and transmission to one or more destination applications. A network 105 for communicatively connecting the Client/Color Selector node 101 to the Web Service 103 may be any available type of network, including a combination of public distributed computing networks (e.g., Internet) and secured private networks (e.g., local area network, wide area network, virtual private network). It may also include wireless and wireline transmission systems (e.g., satellite, cellular network, terrestrial networks, etc.). In at least some aspects, most if not all data transaction functions carried out by the Client/Color Selector node 101 may be conducted over a wireless network, such as a wireless local area network (WLAN) or cellular data network, e.g., to ensure freedom of operation/movement of the user.

In accord with a non-limiting example, a user-generated or user-selected digital color image associated with a target color may be sent in a data packet or other similarly suitable electronic file format from the Client/Color Selector node 101, over the Network 105, to the Web Service 103. The Web Service 103 receives the user-input digital color image, along with user-selected color preferences and other attendant data, that is generated at the Client/Color Selector node 101. At the Web Service 103, the target color data and color preference data are processed so that an Application Process/Rendering Engine 104 can interpret the received data. A Web Browser 107 opened via an image processing application operating on the Client/Color Selector node 101 directs the Web Browser 107 to the relevant data. An electronic display device 106 of the client computer present at the Client/Color Selector node 101 displays to the client a list of one or more matching (“ideal” or “recommended”) colors determined to be harmonious with the one or more target colors and complementary with the user-input color preferences.

Aspects of the present disclosure are directed to a PHI-COLOR HARMONY® web engine that enables a user to perform target color selection, color data management, objective color analysis and harmonization, and matching color visualization. In accord with disclosed techniques, the web engine may be designed to implement the mathematical relationship of Phi proportionality and golden geometries to derive relationships between colors that are “in harmony” and, thus, are deemed to be more aesthetically pleasing to the human eye. Rather than using a subjective perception-based color system to qualitatively identify harmonious colors, disclosed concepts import a finite set of selected “target” colors (e.g., chosen by a user, extracted from a user's digital photograph file, input from a suitable digital image sensor, etc.) into a device-independent, triaxial color space model, such as the CIELAB color space. A list of interrelated harmonious colors may be derived by building a golden geometric object (e.g., rectangle, triangle, circle, spiral, etc.) within the color space in accordance with a predefined rule set that correlates the imported color nodes with the golden object. It should be appreciated that the Golden rectangle is not the only means of calculating Phi-proportional locations for harmonizing colors; Phi-based triangulation, linear relationships, and Fibonacci spirals on color planes may also be utilized. As such, harmonious colors may be derived by locating areas in color space using triangulation, linear variations, and spiral connections where the harmonious colors may be located with special variations that are calculated as having proportional differences that equate to Phi.

The PHI-COLOR HARMONY® web engine may combine scientifically based color evaluation techniques within a CIELAB color space and the concept of Phi dimensionality to decode color harmony. The PHI-COLOR HARMONY® web engine may employ mathematical equations developed to connect language (e.g., system constraints and user-implemented limitations) to control modeled relationships based on the concept of Phi applied within a CIELAB color space. A system of rules may guide the Phi proportions in such a way that the specific direction of color choices (i.e., red, yellow, pink, blue, lighter, darker, more/less chromatic, etc.) creates a harmony between selected “target” colors (e.g., eye color, hair color, skin color, etc.) and derived “matching” or “harmonious” colors (e.g., lipstick color, foundation color, etc.). In a cosmetics application, for example, these rules are applied to determine an optimal lip shade for every foundation color within a specific foundation lineup. For example, a specific hue shift from skin color can determine individual proportion values for different mood-based outcomes, such as “every day wearable” or “dramatic” or “cocktail party” or “soft casual.” Subsequently a “Perfect Phi” aim point may be calculated using multiple sets of rules to locate and determine new product colors or find the “best match” to existing product collections for ideal harmony based on Phi Proportional spacing.

Concepts of color harmony applied in a generic space may be associated with theories of Monochromatic Variations (i.e., namely colors of a common hue that vary only in lightness and Chroma), opponent color, and adjacent/complementary color harmonies related to a color in a conceptual wheel or 3-dimensional (3D) space where a direct opponent color to Red would be Green and a direct opponent to Yellow would be Blue. In complementary color concepts, the component colors in a harmony may triangulate around variations associated with adjacent colors to the principle selection. In an example, the complements of Orange would be Yellow and Red. In each case, the selection of the actual colors proposed as harmonic have historically been based on standardized methodologies within the color system, using a nomenclature of the system which is designed to express attributes of the color, or it is left to personal preference of the observer to make these choices. Aspects of this disclosure, in contrast, dynamically calculate color harmony counterparts factoring in variations that are matching or most closely approximating color differences that are spatially designed to vary proportionally according to the Golden Ratio.

Aspects of the disclosed concepts include evaluating the component colors of color images and colorful objects found in nature, as well as those color combinations created in decorative objects, such as fabrics, and color combinations proposed by others to create combinations that are considered to be harmonic. Through these evaluations, it may be determined that these combinations generally contain spatial variations of color that more closely conform to variations that relate to the Golden Ratio than they would to equal or random variations between the colors when analyzed in a 3D color space. In addition, variations in colors that are in harmony may appear in 3D color planes and fall along spiral lines that are defined by a Fibonacci sequence. A set of rules may be provided to govern how to best navigate color space to find combinations that are appropriate for various project uses, such as cosmetics (e.g., lipstick color selections based on original skin tone), exterior color options for residential and commercial constructions (e.g., door and trim colors harmonized to siding), exterior and interior color options for automobiles, etc.

A unique aspect of this disclosure is that, in addition to the application of rules-based color harmony suggestions, logic is provided for selecting color combinations that most closely conform to spatial variations that closely correspond to Golden Ratios with the use of various Linear, Triadic, and Spiral-Plane methodologies to perform these calculations. While each of these methods may be deployed in standard mathematical color spaces, such as CIE L*a*b* and RGB, more “perfect” color harmony recommendations may be created using disclosed Phi techniques in a digital color space created specifically to generate color harmonies using interpolation of color reflectance curves and Macadam color difference metrics to define Color Space.

The actual perception of colors, however, may be established when it is realized that there are perceptual differences in the appearance of hue for CIE L*a*b* colors of the same integer hue value. Macadam metrics and color reflectance methods may be used to interpolate between theoretical 100% reflectance and zero reflectance across the entire color spectrum using Logical step values between all colors within the spectrum of visible color space. Disclosed techniques may define angles of hue that enable the creation and definition of hue planes that more closely represent human visual perception of harmony for variation in a single common hue that is varied only by lightness or chroma. Combinations of colors of this same hue but of different values—monochromatic combinations—may be characterized as more harmonious and may also be varied in hue chroma and lightness in proportionality based on the above-defined Phi proportional methods and rules.

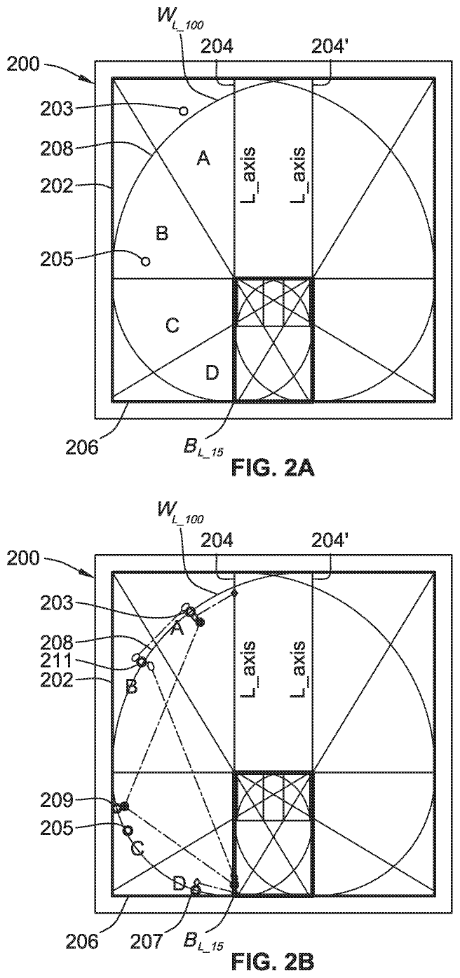

With reference next to FIGS. 2A and 2B, there is shown a two-dimensional representation of a three-dimensional color space model—designated generally as 200—for deriving harmonious colors for target colors using a golden geometric object, in this case a golden rectangle 202. For this example, the color space model 200 expresses color in lightness—from black (0) to white (100) relative to a lightness axis 204 (or “L_axis”) with an extension lightness axis 204′ (or “L_axis”) in a mirrored plane of 3D space—and in hue—from red to green and from blue to yellow along a saturation and chroma plane 206. In accord with the illustrated examples of FIGS. 2A and 2B, 3A and 3B, and 4A and 4B, the color space model is a device-independent, three-dimensional color space, such as a CIELAB color space model, that defines colors independently of how the colors are created or displayed. The color space model may define the three basic dimensions of color characterization, or “colorimetric properties”, as hue, saturation/chroma, and lightness. These three dimensions are also known as “tristimulus data”, i.e., the perceptual attributes of color that allow the brain to interpret and conceptualize the signals it receives through visual stimuli. While described herein with reference to a CIELAB 3D color space, it should be appreciated that many of the disclosed concepts may be employed in other color space models, such as RGB Chromacity Primaries, 1931 XYZ, CMYK, etc.

Upon receipt of the color data files corresponding to user-input target colors, the color data files are transformed into color coordinate points, represented by first and second target color coordinates 203 and 205 in FIGS. 2A and 2B, that are compatible with the multi-axis color space model 200. As noted above, color data may be captured using an electronic color measurement device that optically captures color data, e.g., for the user's skin tone, lip color, hair color, etc., extracted from a digital image uploaded via the user, or via manual selection using an HMI. Each color data file contains characteristic information from which a color's distinct appearance can be defined, e.g., based on three elements: hue (ROYGBV), chroma (saturation, vividness, dullness), and value (luminous intensity, lightness). For CIELAB applications, each color coordinate includes a respective L*a*b color coordinate set (L*, a*, b*): a lightness (first) coordinate L* for the black-to-white (first) axis of the 3D color space, a G-R color channel (second) coordinate a* for a red-to-green (second) axis of the 3D color space, and a Y-B color channel (third) coordinate b* for a yellow-to-blue (third) axis of the 3D color space. The above color space maps position and range in a Cartesian-type XYZ coordinate system, with different degrees of color and fineness to express a certain color. Once converted, the color coordinate points corresponding to the target colors are imported into, and concomitantly mapped within, the color space model 200. A CIELAB color coordinate set can be converted to the other 3D color space models noted above, e.g., by using formulas under a predefined white reference (D65, D50, A, C, D55, D75) and observer view angle (2°, 10°). While not per se required, the user may be restricted to a maximum number of target colors, e.g., for computational efficiency and accuracy by ensuring the golden object can encapsulate all target colors

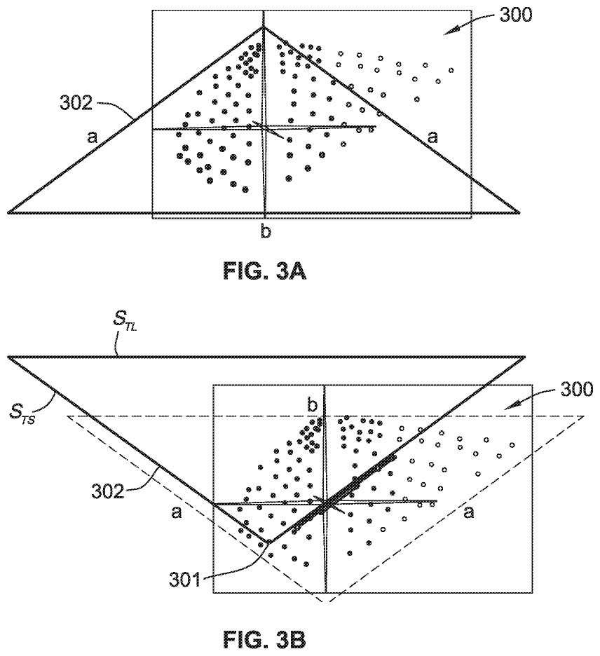

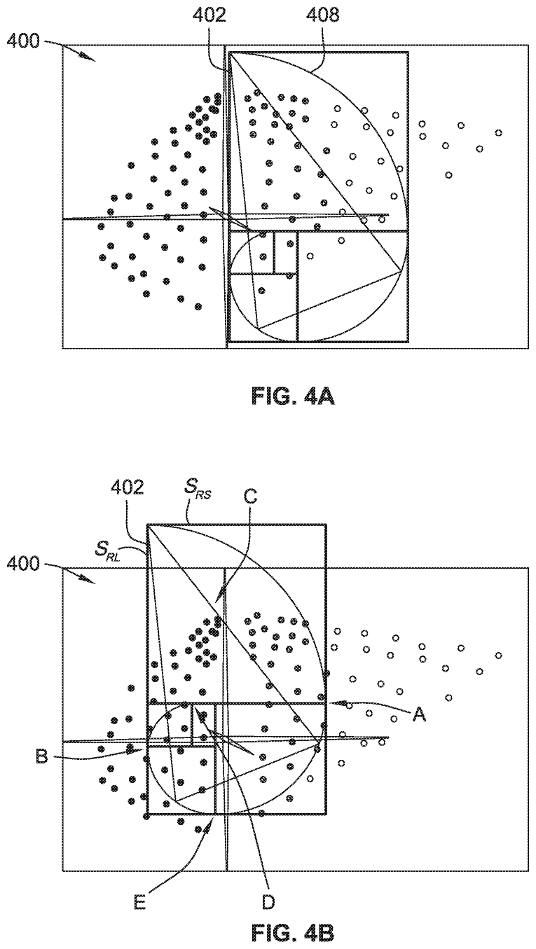

For any of illustrated implementations, a golden geometric object may be dynamically built, e.g., in real-time or near real-time, for each new color harmony analysis. As indicated above, the golden geometric object may take on numerous phi-compliant forms, such as the golden rectangles 202 and 402 of FIGS. 2A-2B and FIGS. 4A-4B, respectively, and the golden triangle of FIGS. 3A and 3B. To be considered a “golden rectangle,” a ratio between the length of a short side (e.g., short side SRS of FIG. 4B) of the rectangle and the length of a long side (e.g., long side S_{RL}, of FIG. 4b) of the rectangle is approximately equal to 1.618. In the same vein, a “golden triangle” may be typified as an isosceles triangle in which a ratio between the length of a duplicated short side (e.g., short side S_{TS} of FIG. 3B) of the triangle and the length of a long side (e.g., long side S_{TL} of FIG. 3B) of the triangle is approximately equal to 1.618. As best seen in FIGS. 2A and 2B, a golden spiral 208 (or “spline”) is built along with and located inside the golden rectangle 202. In accord with the illustrated example, the golden spiral 208 is a Fibonacci spiral with a logarithmic growth factor of approximately 1.618. The golden rectangle 202 can be calculated in variable scales and on any plane in the color space 200.

Prior to, contemporaneous with, or after constructing the golden geometric object, the system may dynamically locate and orient the golden geometric object within the 3D color space. As a default, for example, the golden rectangle 202 may initially be attached to the lightness axis 204/204′ and/or the saturation/chroma plane 206 in the examples shown. The system may subsequently reposition the golden rectangle 202 to attach any logical point on or in the geometric shape to a target color, and then rotate/size the golden rectangle 202 to encapsulate or intersect the remaining target colors. In the example of FIGS. 3A and 3B, in a golden triangle 302 is dynamically repositioned within the 3D color space 300 to locate a first of the three points of the triangle 302 on a first target color 301. Golden triangle 302 is then expanded or “stretched” to scale around color space to locate colors that match the location of the other two points of the triangle that are Phi-proportional to the target color in 3D color space 300.

With continuing reference to FIGS. 2A and 2B, the system may dynamically define a curve of a color family by moving the golden spiral 208 as a “spline” until it bisects one or more or all of the target colors 203, 205 selected by the user. A reference white point W_{L_100} and a reference black point B_{L_15} is are designated on lightness axis 204, 204′ and remain fixed when defining the color family curve. A set of neighboring regions A, B, C, and D may be defined within the golden rectangle 202 to help identify, e.g., from a set of predefined, memory-stored rule sets, a corresponding rule set that will describe the manner in which the matching color or colors are calculated with respect to the color coordinate points 203, 205 within the three-axis color space model 202 using phi proportionality. As shown, the length of the segment of the golden spiral 208 in region A is phi-proportional to the length of the segment of the golden spiral 208 in region B, and the length of the segment of the golden spiral 208 in region C is phi-proportional to the length of the segment of the golden spiral 208 in region D.

After defining the curve of the color family, as seen in FIG. 2B, the system ascertains, for each target color/color data file, within which of the regions A, B, C, and D does the golden spiral 208 intersect with the corresponding color coordinate point in the color space model 200. In the event a reference target color falls on the golden spiral 208 (also referred to herein as “color curve” or “curve”) in region A, for example, the user is then queried to select a number of desired matching colors (e.g., 1, 2, 3, etc.) and a color type or types for the matching colors (e.g., deep mono color, mid color, a light color, etc.). If the user selects a single deep mono color, a corresponding rule set instructs the system to calculate a linear distance from the target color 203 to the white point W_{L_100}, and then select a matching color 207 that is on the curve 208 and that same linear distance from the black point B_{L_15}. By way of comparison, if the user selects a single mid color, another corresponding rule set instructs the system to calculate a linear distance from a target color 203 to black point B_{L_15}, and thereafter select a matching color 209 that is located on the curve 208 and is proportionally 1:1.62 spaced away from the target color 203 with the shorter distance being to point B_{L_15}. If, however, the user selects a single light color, a rule set instructs the system to calculate a linear distance from a target color 203 to white point W_{L_100}, and thereafter select a matching color 211 that is located on the curve 208 and is proportionally 1:1.62 spaced away from the target color 203 with the shorter distance being to point W_{L_100}.

In the event a reference target color falls on the curve 208 in region B or region C or region D, the user is similarly queried to select a number of desired matching colors and a color type/types for the matching colors. In instances where the reference target color falls on the curve 208 in regions B or C and the user selects a single deep mono color, a rule set instructs the system to calculate a linear distance from a reference target color to the black point B_{L_15}, and select a matching color that is located on the curve 208 and is proportionally 1:1.62 spaced away from the target with the shorter of the two distances is the distance to point B_{L_15}. If the user selects a single light color, however, the system may select a matching color point which is 1.62 proportionally between the target and a reference white point. If a single mid color is selected, the system selects a matching color point that is 1 to 1.62 toward a reference black point (for region B) or a reference white point (for region C) with the shorter distance to the target color. In the event a reference target color falls on the curve within region D, the system reverse the rule sets enumerated above for region A.

With continuing reference to FIGS. 2A and 2B, in the event a reference target color falls on the curve 208 in regions A, B, C or D, and a user selects two or more mono colors, the corresponding rule set for such scenarios instructs the system to select a matching color point that is or is closest to 1.62 DE from the white point W_{L_100} value on the spline 208. Delta_E or DE is a metric unit that determines the amount of visible difference between any two discreet colors. One (1) DE is theoretically the point at which any two discreet colors become visibly different to the human eye. An “ideal” phi proportionality may involve any combination of colors being spaced based on special variations of those colors conforming to the DE being equivalent to ratios of a 1:1.62 DE difference. The system may then calculate and catalogue multiple other “colors” from the reference white point.

In the event a target color falls on the curve 208 in region A and the user selects two or more mono colors, the system is instructed to calculate a distance from a target color to a black reference point (e.g., black point B_{L_15}) and select two or more matching color points that are proportionally 1:1.62 spaced away from target, where the two shorter distances are the distance to black point B_{L_15} and the target color. Upon selection of three additional mono colors: if a reference target color in region A is less than half way to region B, select three matching color points as with two matching colors. If a reference target color in region A is closer to region B than a white reference point (e.g., white point W_{L_100}), the system calculates a first matching color point as toward white and places the second matching color point away from black the same distance as the target. Additional examples of color selection are provided in the Appendix filed with U.S. Provisional Patent Application No. 62/855,325; the Appendix is incorporated herein by reference in its entirety and for all purposes.

A “white point” may be a set of tristimulus values or chromaticity coordinates that serve to define the color “white” in image capture, encoding, or reproduction. For the purposes of calculating phi-harmony color combinations, the white point may be set to an arbitrary value that establishes the most pure white for the color palette being used for review. By contrast, a “black point” may be a set of tristimulus values or chromaticity coordinates that serve to define the color “black” in image capture, encoding, or reproduction. For the purposes of calculating phi-harmony color combinations, the black point may be set to an arbitrary value that establishes the most pure black for the color palette being used for review. A “curve” or “spline” may allow a user to design and control the shape of complex color curves along which a set of color points can be calculated to be phi-proportionally spaced. A “deep mono color” may be defined to include a darkest point of a phi-proportional set of matching colors that is calculated based on a scheme that retains similarity of hue that may be described as a monochromatic color scheme. A “mid color” may be defined to include a color or set of colors that fall in a phi-proportional spacing between the lightest and darkest points of a phi-proportional color set. A “light color” may be defined to include a lightest point of a phi-proportional set of matching colors.

Presented in FIGS. 3A and 3B and FIGS. 4A and 4B are examples of three-dimensional color space models 300 and 400, respectively, with phi-compliant golden geometric objects, namely golden triangle 302 of FIGS. 3A-3B and golden rectangle 402 of FIGS. 4A-4B, for deriving a list of one or more harmonious colors for a user-derived set of target colors. In FIG. 3A, for example, a chromatic family is identified by first setting the size of the golden triangle 302 (a=Lₐ; b=1.62×Lₐ), which may be based on the apex of the isosceles triangle 302 being positioned at a first L*a*b color coordinate set (100, 0, 0) and the center of the base being positioned at a second L*a*b color coordinate set (10, a*, 0). To calculate a set of matching color points, the golden triangle 302 is repositioned (e.g., raised, lower, swiveled, etc.) within 3D color space model 300 until a target color falls on an A line. A length of this A line, as a variable, may be set as a distance from the point of c=5% axis to 100% C value on that axis. Based on the number of target colors in the corresponding family, the system may calculate a “best fit” for phi-spaced data points from the location of the target color to the vertical L-axis, with progressively smaller spaces going toward C=5. For at least some applications, c=5% is displayed as “neutral” and other selections are “colors”. Based on this calculation, if in-gamut selections are available with a greater C-value, these selections may also be included as an option to allow for setting of “neutral” to “pure grey” at C=0.

For a dark chromatic family, the phi-compliant golden triangle 302 (a=Lₐ; b=1.62×Lₐ) may be sized based on the triangle's apex being located at a first L*a*b color coordinate set (10, 0, 0) and the center of the triangle's base being located at a second L*a*b color coordinate set (100, a*, 0). To calculate a set of matching color points, the golden triangle 302 is repositioned within 3D color space model 300 until a target color falls on the A line. A length of the A line, as a variable, may be set as a distance from the 5% C value to the 95% L value on that axis. Based on the number of target colors in the corresponding family, the system may calculate a “best fit” for phi-spaced data points from the location of the target color to 5% C-axis with progressively smaller spaces going towards C=5%. Based on this calculation, if in-gamut selections are available with a greater C-value, these selections may also be included. For chromatic and dark chromatic family complements, a size of the golden triangle 302 may be based on the triangle's apex meeting at coordinate L*10 a*0 b*0 and the center of the triangle's base meeting at coordinate L*100 a* b*0. To calculate matching colors, extend a line along the diagonals using phi proportions to locate colors within a gamut of a complementary hue angle.

With reference to FIGS. 4A and 4B, single color complementary options may be determined via dynamic modulation of the golden rectangle 402 within 3D color space model 400. The golden rectangle 402 may be dynamically sized such that one of the equiangular quadrilateral's long sides extends from L* 0 to L* 100. For a first complement option, an edge line of a rectangular region D may be limited so as to not go beyond C=5 from a complementary hue space. In a scenario in which this may occur, a size of the color spiral 408 may be increased to allow point A to move to high-chroma-value colors and locate the first complement at point B.

For additional complement options, a reference target color may be located at point A; a first complement may be found at point B. If a light color in opposing hue space bisects the line C, a “light” complement may also be included at that location. A neutral complement may be included from point D and a dark complement may be included from Point E. Where Point E is at C=5, the size of the curve 408 may be expanded to allow a target color to be placed at point A to keep point E in complementary space. For a pro version, light and dark complements may be allowed using a family arc from Point B with light value at 1.62 DE from white and dark at 1.62 from this point to B. Additional examples of identifying complementary colors and analogous color options can be found in the Appendix of U.S. Provisional Patent Application No. 62/855,325.

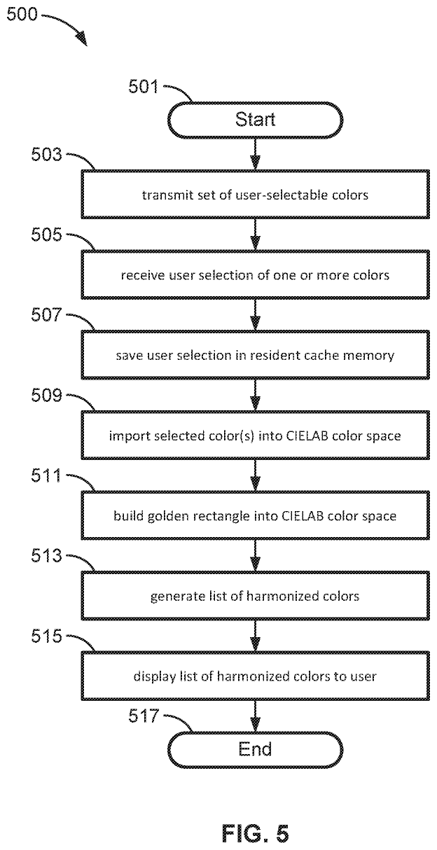

With reference now to the flowchart of FIG. 5, an improved method or control strategy for performing quantitative analysis of colors to objectively derive color harmony is generally described at 500 in accordance with aspects of the present disclosure. Some or all of the operations illustrated in FIG. 5 and described in further detail below may be representative of an algorithm that corresponds to processor-executable instructions that may be stored, for example, in main or auxiliary or remote memory, and executed, for example, by a resident or remote controller, processing unit, control logic circuit, or other module, device, and/or network of devices, to perform any or all of the above or below described functions associated with the disclosed concepts. It should be recognized that the order of execution of the illustrated operation blocks may be changed, additional blocks may be added, and some of the blocks described may be modified, combined, or eliminated.

At terminal block 501, the process initializes, e.g., when a back-end, server-class computer provisions a login screen to an end user with a prompt to enter personal identification information (e.g., an email and a password) when arriving at the PHI-COLOR HARMONY® web engine portal. Method 500 continues to input/output block 503 with the server-class computer outputting a set of user-selectable colors, which may be selected manually by the end user or selected from a digital photo uploaded via the end user. The user-selectable colors may be organized and displayed for selection as a standardized set of discrete hues (e.g., a CIELAB hue wheel) distributed over a visible spectrum that is perceivable by the human eye. Proceeding to input/output block 505, the method 500 provides processor executable instructions for one or more processors of the server-class computer to receive, over a distributed computing network from the user's personal computing device, selections from the user-selectable colors, including one or more of the discrete hues. The received selections are saved to a resident or remote memory device, such as cache computer memory storage, at process block 507.

Method 500 advances to predefined process block 509 and imports the selected color or colors into a device-independent, three-axis color space model. By way of non-limiting example, CIELAB or CIE L*a*b* color space provides a perceptually uniform color space within which the distance between two points approximates how different the colors are in terms of luminance, chroma, and hue. Prior to, contemporaneous with, or after importing the colors into the color space model and mapping their respective coordinates to the 3D space, a golden geometric object, i.e., an object characterized by the mathematical Golden Ratio, is built within the color space model, at predefined process block 511. At process block 513, the server-class computer generates a list of colors harmonized with the imported user-selected color(s) by correlating the golden geometric object with the discrete hues mapped in the three-axis color space model. This list is transmitted to and concomitantly displayed by an electronic display of the user's personal computing device, at input/output block 515. For example, the user may upload to the system a digital image (e.g., a picture of themselves), and the system may dynamically alter aspects of that image (e.g., the user's lip color) in real-time to visualize and manipulate the harmonious “matching” colors. At this juncture, the method 500 may advance from to terminal block 517 and terminate, or may loop back to terminal block 501 and run in a continuous loop.

As is readily apparent to persons skilled in the art, the above control operations are not mere commonplace method steps aimed solely at processing and/or disseminating information, do not propose to merely apply a previously known process to the technological environment of computers or the Internet, and do not merely create or alter contractual or other business relations using generic computer functions and conventional network operations. Rather, disclosed features are directed to a specific implementation (e.g., automated color data aggregation and transformation with concomitant mapping in multidimensional color space) of a solution (e.g., using mathematical descriptors and golden geometric objects that connect color variants based on the Golden Ratio to automate evaluation and harmonization of color sets with Phi dimensionality) to a problem in the software arts (e.g., reduce processing burden and attendant latency times associated with existing software and web tools, provision logical structures with concrete assignment of specific computer functions to improve CIELAB color space coordination, eliminate human-borne error and subjective contamination associated with manual evaluation and harmonization, etc.). Many of the control operations illustrated, described, and claimed herein cannot be carried out as a mental process by pad and pen, including digital image processing and normalization, file adaption and transformation through color coordinate conversion, uniform 3D color space mapping, golden object building and scaling, etc.

Disclosed features provide a specific process for automatically processing, analyzing, and converting a digital color image using particular digital-image-extracted information and conversion techniques, without preempting other existing and hereafter developed approaches. Since many of the control operations illustrated, described, and claimed herein are novel, and not mere implementations of previously applied techniques on a computer system, others are not forestalled from utilizing those known and conventional techniques. When looked at as a whole, these features are technological improvements over existing, manual color image processing techniques to achieve improved color data mapping, evaluation, and harmonization results. Disclosed features do not merely implement a mathematical algorithm in an abstract manner, but rather describe systems and methods that use optical sensing devices in a non-conventional manner to reduce errors in deriving features and aspects of an imaged color. In this regard, improved graphical user interfaces for integrated circuit devices are presented that encompass a particular manner of summarizing, visualizing, and manipulating image color data that help to ameliorate problems with objective color harmonization and also help to improve device efficiency by its organization of information.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state memory, a CD-ROM, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of calculating matching colors for color data input by a user, the method comprising:
receiving, by a computer device from the user via a human-machine interface, a plurality of color data files corresponding to user-input target colors;
transforming, via the computer device, each of the color data files into a respective color coordinate point integrable with a three-axis color space model;
importing the color coordinate points into the three-axis color space model;
building, within the three-axis color space model, a golden geometric object based on a mathematical golden ratio and the imported color coordinate points;
identifying, via the computer device, a list of one or more matching colors harmonized with the color data files by correlating the golden geometric object with the color coordinate points imported into the three-axis color space model; and
transmitting, to an electronic display device, a command signal to display to the user the list of one or more matching colors.

2. The method of claim 1, wherein the three-axis color space model is a device-independent three-dimensional (3D) color space configured to define colors independently of how the colors are created or displayed.

3. The method of claim 2, wherein transforming each of the color data files into a respective color coordinate points includes identifying, for each of the color data files, a respective L*a*b color coordinate set, the L*a*b color coordinate set including a first coordinate L* for a first axis of the 3D color space, a second coordinate a* for a second axis of the 3D color space, and a third coordinate b* for a axis of the 3D color space.

4. The method of claim 1, wherein the golden geometric object includes a golden rectangle in which a ratio between a short side length and a long side length of the golden rectangle is approximately equal to 1.618.

5. The method of claim 4, wherein the golden geometric object further includes a golden spiral located within the golden rectangle and having a logarithmic growth factor of approximately 1.618.

6. The method of claim 1, wherein the golden geometric object includes a golden triangle in which a ratio between a short length of two short sides of the golden triangle and a long length of a long side of the golden triangle is approximately equal to 1.618, the golden triangle having an isosceles triangle shape.

7. The method of claim 1, further comprising locating the golden geometric object within the three-axis color space model such that all of the color coordinate points are located within or on a boundary line of the golden geometric object.

8. The method of claim 1, further comprising:
defining a color curve within the golden geometric object; and
moving the color curve to intersect with the color coordinate points in the three-axis color space model.

9. The method of claim 8, further comprising:
defining a plurality of neighboring regions within the golden geometric object; and
determining, for each of the color data files, within which one of the regions the color curve intersects with the corresponding color coordinate point in the three-axis color space model.

10. The method of claim 9, further comprising:
receiving a selection of a desired color type from the user; and
determining, for each of the color data files based on the desired color type received from the user, a respective rule set associated with the region within which the color curve intersects with the corresponding color coordinate point,
wherein the rule sets define a manner in which a matching color is located with respect to the color coordinate point within the three-axis color space model based on phi.

11. The method of claim 1, further comprising displaying to the user a predefined set of user-selectable color options each corresponding to a respective color data file, wherein receiving the color data files includes receiving, from the user via the human-machine interface, multiple user selections from the predefined set of user-selectable color options.

12. The method of claim 1, wherein the computer device includes a server-class computer and the human-machine interface includes a personal computing device and/or an optical color sensor communicatively connected to the server-class computer over a distributed computing network.

13. A computing system for identifying matching colors for color data input by a user, the distributed computing system comprising:
a memory device storing a three-axis color space model;
a communications device operable to communicate with a personal computing device of a user over a computing network; and
a server computer with a processor communicatively connected to the memory device and the communications device, the processor being programmed to:
receive, from the user via the personal computing device, a plurality of color data files corresponding to user-input target colors;
transform each of the received color data files into a respective color coordinate point integrable with the three-axis color space model;
import the color coordinate points into the three-axis color space model;
build, within the three-axis color space model, a golden geometric object based on a mathematical golden ratio and the imported color coordinate points;
identify a list of one or more matching colors harmonized with the color data files by correlating the golden geometric object with the color coordinate points imported into the three-axis color space model; and
transmit, to the personal computing device of the user for display via an electronic display device, the list of the one or more matching colors.

14. The computing system of claim 13, wherein the three-axis color space model is a device-independent three-dimensional (3D) color space configured to define colors independently of how the colors are created or displayed.

15. The computing system of claim 14, wherein transforming the color data files into respective color coordinate points includes identifying, for each of the color data files, a respective L*a*b color coordinate set, the L*a*b color coordinate set including a first coordinate L* for a first axis of the 3D color space, a second coordinate a* for a second axis of the 3D color space, and a third coordinate b* for a third axis of the 3D color space.

16. The computing system of claim 13, wherein the golden geometric object includes a golden rectangle in which a ratio between a short side length and a long side length of the golden rectangle is approximately equal to 1.618.

17. The computing system of claim 16, wherein the golden geometric object further includes a golden spiral located within the golden rectangle and having a logarithmic growth factor of approximately 1.618.

18. The computing system of claim 13, wherein the processor of the server computer is further programmed to:
define a color curve within the golden geometric object; and
move the color curve to intersect with the color coordinate points in the three-axis color space model.

19. The computing system of claim 18, wherein the processor of the server computer is further programmed to:
define a plurality of neighboring regions within the golden geometric object; and
determine, for each of the color data files, within which one of the regions the color curve intersects with the corresponding color coordinate point in the three-axis color space model.

20. The computing system of claim 19, wherein the processor of the server computer is further programmed to:
receive, from the personal computing device of the user, a desired color type; and
determine, for each of the color data files based on the desired color type received from the user, a respective rule set associated with the region within which the color curve intersects with the corresponding color coordinate point,
wherein the rule sets define a manner in which a matching color is located with respect to the color coordinate point within the three-axis color space model based on phi.
